(19) United States
(12) Patent Application Publication
(10) Pub. No.: US 2017/0244252 A1
(43) Pub. Date: Aug. 24, 2017

(54) Autonomous Operational Platform for Micro-Grid Energy Management

(71) Applicant: NEC Laboratories America, Inc., Princeton, NJ (US)

(72) Inventors: Kiyoshi Nakayama, Santa Clara, CA (US); Ratnesh Sharma, Fremont, CA (US)

(21) Appl. No.: 15/436,274

(22) Filed: Feb. 17, 2017

Related U.S. Application Data
(60) Provisional application No. 62/298,516, filed on Feb. 23, 2016.

(51) Int. Cl. H02J 3/38; G05B 23/02

(52) U.S. Cl. CPC H02J 3/381; G05B 23/0294

(57) ABSTRACT

A computer-implemented method is provided for managing a plurality of micro grids in an energy system. The method includes collecting and maintaining, in a central database, configuration information and state information for the plurality of micro grids, by a processor-based dynamic operation engine. The method further includes identifying failures in any of the plurality of micro grids and generating updated configuration information and updated state information relating to the failures, based on data analytics and diagnostic polling applied to the configuration information and the state information, by a processor-based micro grid diagnostic engine. The method also includes autonomously recovering from the failures in any of the plurality of microgrids using one or more backup devices determined based on the updated configuration information and the updated state information, by a processor-based system recovery engine operatively coupled to the processor-based dynamic operation engine and to the processor-based micro grid diagnostic engine.

### RELATED APPLICATION INFORMATION

This application claims priority to provisional application Ser. No. 62/298,516 filed on Feb. 23, 2016, incorporated herein by reference.

### BACKGROUND

Technical Field

The present invention relates to energy management, and more particularly to autonomous operational platform for micro grid energy management.

Description of the Related Art

An operator at a utility or aggregator needs to monitor and manage a micro grid(s) and its systems and devices (e.g., batteries, PhotoVoltaics (PVs), load devices, diesel generators, and so forth) with an Energy Management System (EMS) that can optimize, control, support, and scale the systems and devices. In addition, a utility or an aggregator will have to develop and deploy multiple micro grids within a region under their authority.

Thus, there is a need for an autonomous operational platform for micro grid energy management.

### SUMMARY

These and other drawbacks and disadvantages of the prior art are addressed by the present principles, which are directed to autonomous operational platform for micro grid energy management.

According to an aspect of the present invention, a computer-implemented method is provided for managing a plurality of micro grids in an energy system. The method includes collecting and maintaining, in a central database, configuration information and state information for the plurality of micro grids, by a processor-based dynamic operation engine. The method further includes identifying failures in any of the plurality of micro grids and generating updated configuration information and updated state information relating to the failures, based on data analytics and diagnostic polling applied to the configuration information and the state information, by a processor-based micro grid diagnostic engine. The method also includes autonomously recovering from the failures in any of the plurality of microgrids using one or more backup devices determined based on the updated configuration information and the updated state information, by a processor-based system recovery engine operatively coupled to the processor-based dynamic operation engine and to the processor-based micro grid diagnostic engine.

According to another aspect of the present invention, a computer-based energy management system is provided for managing a plurality of micro grids in an energy system. The system includes a processor-based dynamic operation engine for collecting and maintaining, in a central database, configuration information and state information for the plurality of micro grids. The system further includes a processor-based micro grid diagnostic engine for identifying failures in any of the plurality of micro grids and generating updated configuration information and updated state information relating to the failures, based on data analytics and diagnostic polling applied to the configuration information and the state information. The system also includes a processor-based system recovery engine, operatively coupled to the processor-based dynamic operation engine and to the processor-based micro grid diagnostic engine, for autonomously recovering from the failures in any of the plurality of microgrids using one or more backup devices determined based on the updated configuration information and the updated state information.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 show a block diagram for an exemplary processing system to which the present principles may be applied, according to an embodiment of the present principles;

FIG. 2 show a block diagram for an exemplary architecture of an autonomous operational platform for micro grid energy management, in accordance with an embodiment of the present invention;

FIGS. 3-5 show a block diagram for exemplary database information relating to the EMS Operational Platform of FIG. 2;

FIGS. 6-7 show a flow diagram for a method performed by the dynamic operation engine of FIG. 2, in accordance with an embodiment of the present invention;

FIGS. 8-9 show a flow diagram for a method 800 performed by the micro grid diagnostic engine 212 of FIG. 2, in accordance with an embodiment of the present invention;

FIG. 10-11 show a flow diagram for a method performed by the system recovery engine of FIG. 2, in accordance with an embodiment of the present invention; and

FIGS. 12-15 show a block diagram for another layout of an autonomous EMS Operational Platform architecture, in accordance with an embodiment of the present invention.

### DETAILED DESCRIPTION OF PREFERRED EMBODIMENTS

The present invention is directed to autonomous operational platform for micro grid energy management.

In an embodiment, an autonomous EMS Operational Platform is provided to monitor, manage, and optimize all the micro grids and their devices in a consistent, resilient, and effective manner.

In an embodiment, the autonomous EMS Operational Platform addresses the problem of enhancing, updating, and recovering the multiple EMS components of micro grids in a real-time manner without affecting or stopping the other systems that are already running, which is defined by a dynamic configuration and the operations of multiple micro grids and devices. For example, when adding a micro grid to a currently running EMS platform, its operational and systematic information should automatically be registered in a database that is accessed by the operational platform so that the information of the new micro grid is configured in a real-time manner and used for a next-step operation and optimization of the EMS based on inputs of an operator and/or any other algorithmic solutions implemented in an optimization engine in the EMS.

The present invention can quickly detect failures that may happen in micro grids or to their devices and, when possible, recover autonomously using back-up devices and recovery mechanisms. The dynamic and autonomous schemes for the failure recovery are important to minimize the cost caused from the interruption of the running grids and systems.

The present invention can minimize the operational cost of setting up, enhancing, updating, and recovering the energy management systems without stopping and/or interrupting the running systems, which leads to significant benefits to both customers and utility operators.

In an embodiment, an autonomous EMS Operational Platform is provided that enables dynamic operations including diagnostic mechanism for outlier and failure detection and recovery scheme to maintain and enhance the energy management platform that can support multiple micro grids and those systems. As used herein, the term “failure” can encompass an “outlier” in a managed micro grid.

The present invention provides a dynamic configuration mechanism of an EMS for scalable operation that can update and enhance the systems as well as recover from failure without causing any interruptions. The proposed operational platform dynamically aggregates the micro grid agents that control or manage micro grid devices while operating the grids using centralized scalable database that can store the measurement data from the agents to access the micro grid devices.

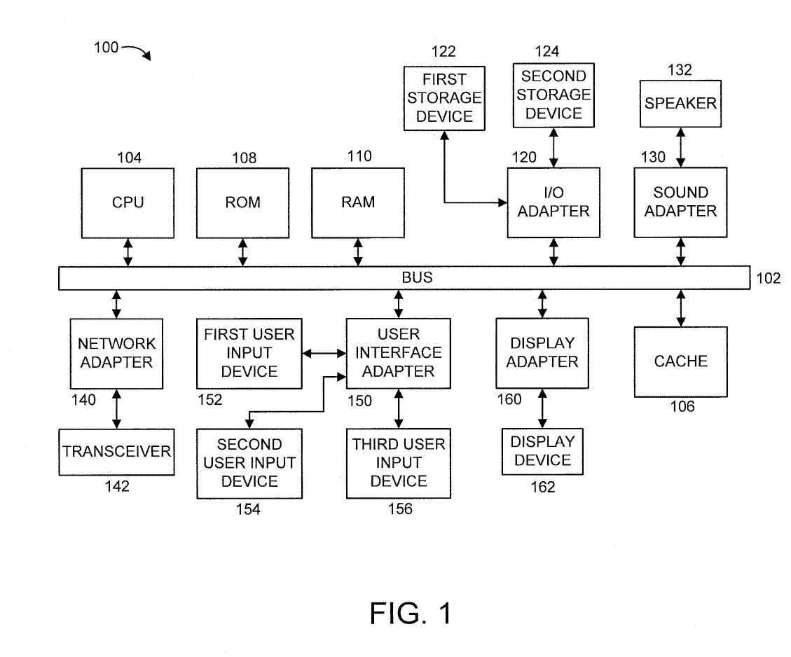

Referring now in detail to the figures in which like numerals represent the same or similar elements and initially to FIG. 1, a block diagram illustrating an exemplary processing system 100 to which the present principles may be applied, according to an embodiment of the present principles, is shown. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

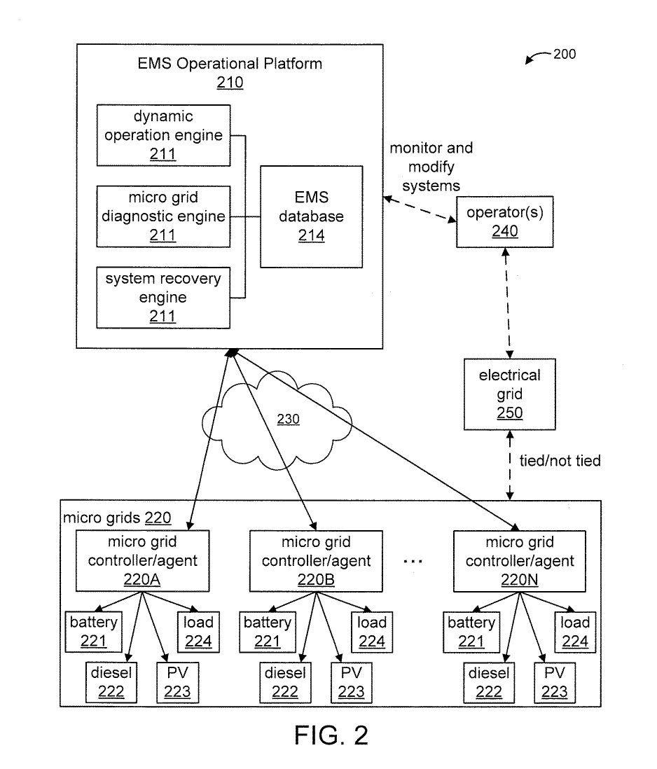

Moreover, it is to be appreciated that system 200 described below with respect to FIG. 2 is a system for implementing respective embodiments of the present principles. Part or all of processing system 100 may be implemented in one or more of the elements of system 200.

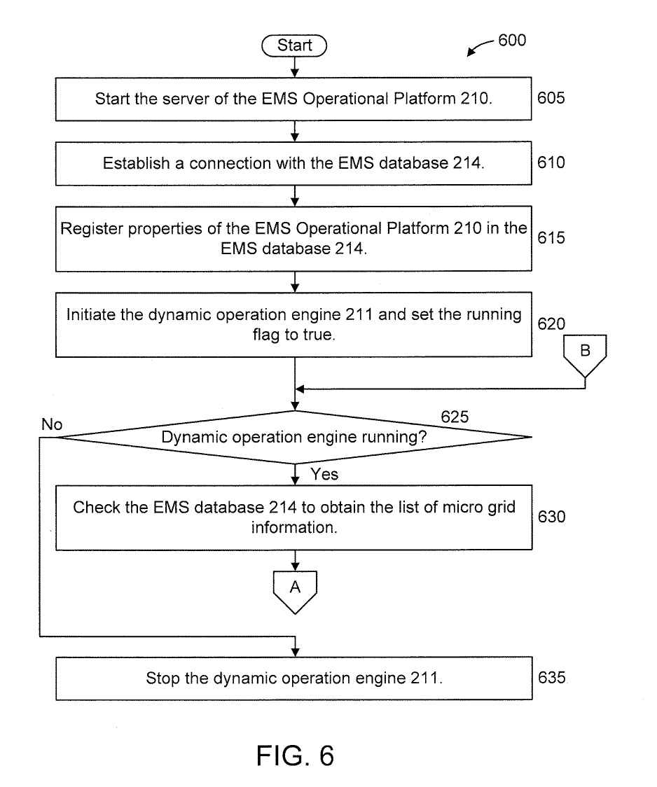

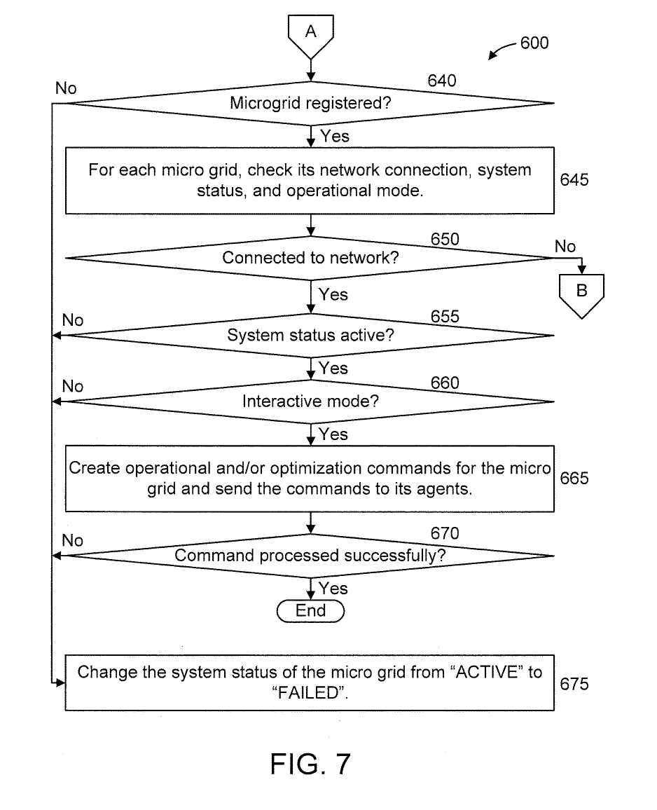

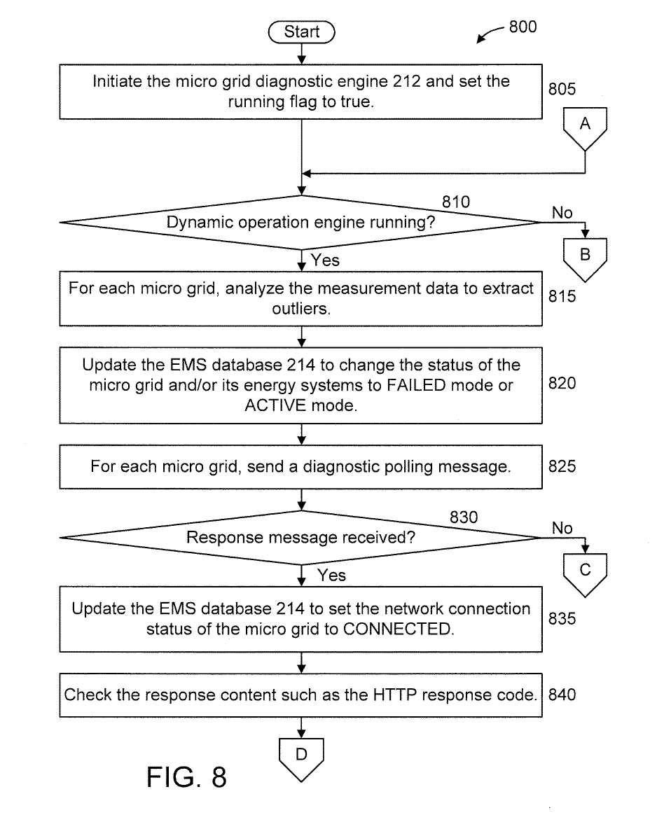

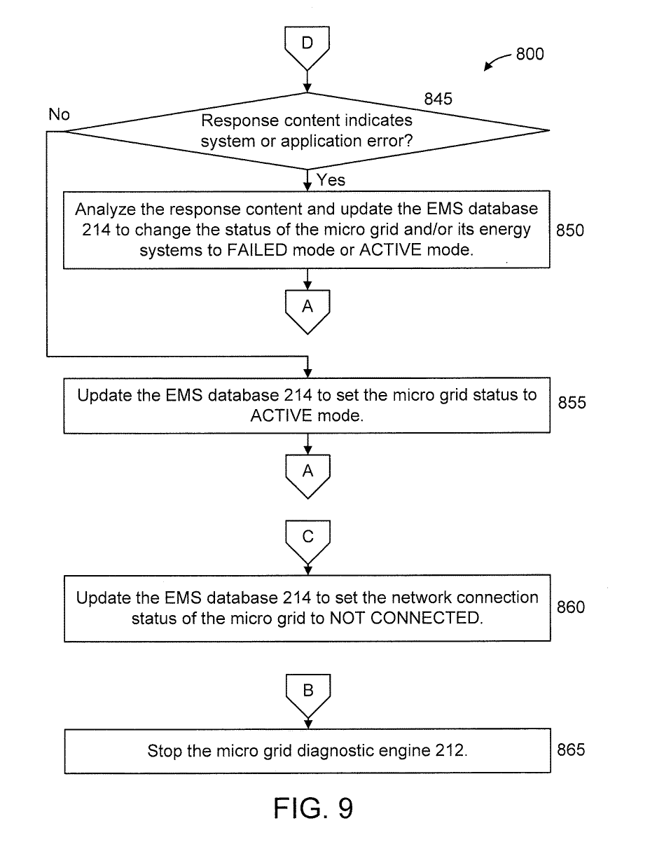

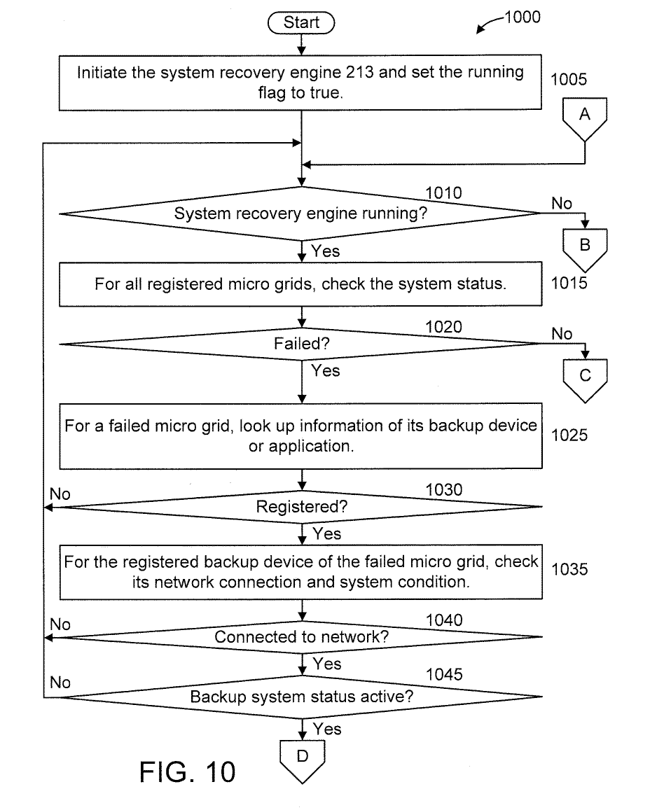

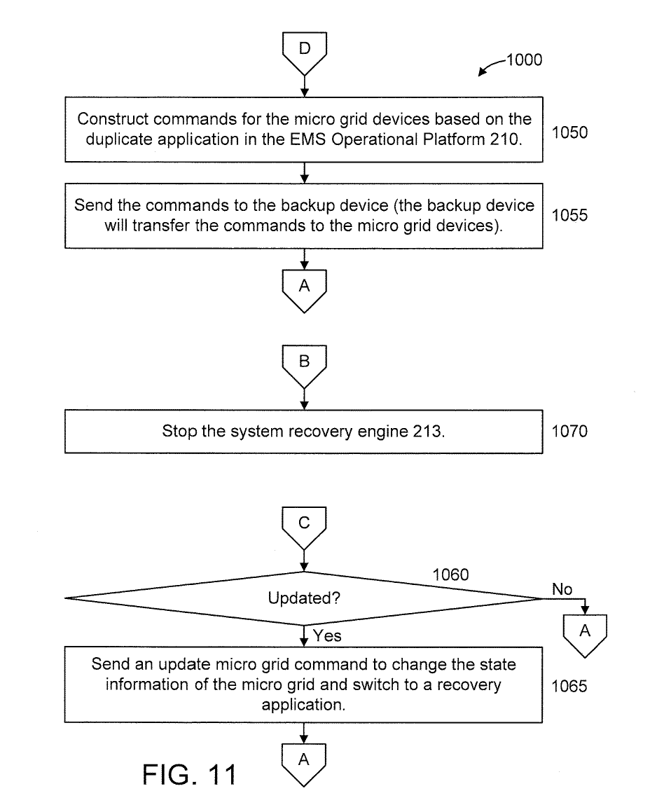

Further, it is to be appreciated that processing system 100 may perform at least part of the method described herein including, for example, at least part of method 600 of FIGS. 6-7 and/or at least part of method 800 of FIGS. 8-9 and/or at least part of method 1000 of FIGS. 10-11. Similarly, part or all of system 200 may be used to perform at least part of method 600 of FIGS. 6-7 and/or at least part of method 800 of FIGS. 8-9 and/or at least part of method 1000 of FIGS. 10-11.

FIG. 2 shows an exemplary architecture 200 of an autonomous operational platform for micro grid energy management, in accordance with an embodiment of the present invention.

The architecture 200 includes an EMS operational platform 210 and micro grids collectively denoted by the figure reference numeral 220.

The EMS operational platform 210 includes a dynamic operation engine 211, a micro grid diagnostic engine 212, a system recovery engine 213, and an EMS database 214. The engines 211, 212, and 213 can be processor-based in that their use employs one or more processors. The processors can be different for each (or at least two) of the engines 211, 212, and 213 or a single processor can be shared amongst all the engines 211, 212, 213. These and other variations of the engines 211, 212, and 213 are readily determined by one of ordinary skill in the art given the teachings of the present invention provided herein, while maintaining the spirit of the present invention. Thus, in an embodiment, software executed by one or more processors can be employed, or special purpose integrated circuits or specialized circuitry can be employed, depending upon the implementation.

The micro grids 220 include micro grid controller/agents 220A-220N. Each of the micro grids 220 include a battery 221, a diesel generator 222, a PhotoVoltaic (PV) 223, and a load 224.

The EMS Operational Platform 210 can talk to each micro grid via the Internet or any network (collectively denoted by the figure reference numeral 230) that can connect the micro grids 220 and the EMS Operational Platform 210. The EMS Operational Platform 210 provides operators 240 with User Interface (e.g., a web-based Graphical User Interface (GUI)) that shows system configuration status, system condition, data analytics results, and so forth. The micro grids 220 are connected to the utility electrical grid 250 so that there are “grid-tied” and “non-tied modes” for each of the micro grids 220. Each of the micro grids 220 is equipped with software and/or any virtual application(s) to manage the grid devices (e.g., batteries 221, diesel generators 222, PVs 223, loads 224), with such software and/or virtual application(s) being interchangeably referred to here as micro grid controllers/agents 220A-220N.

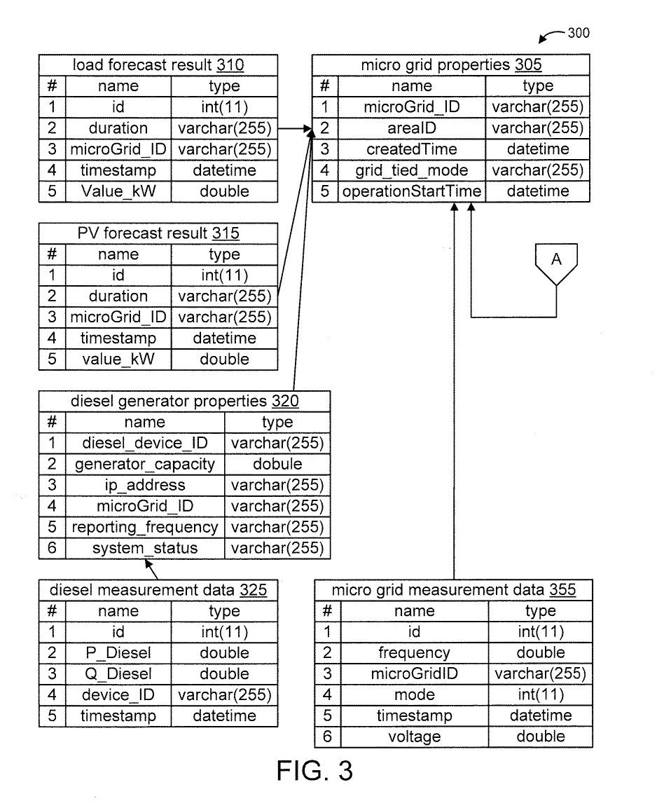

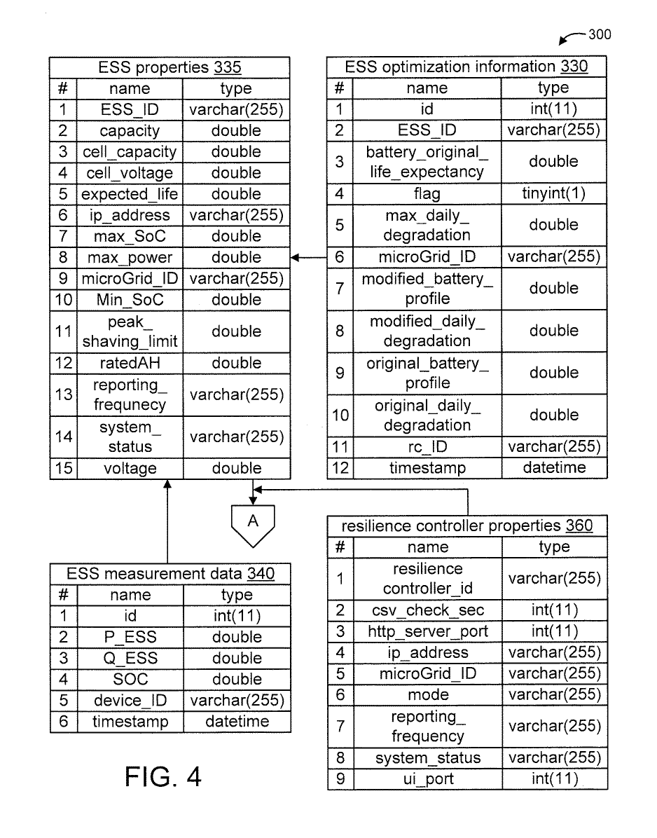

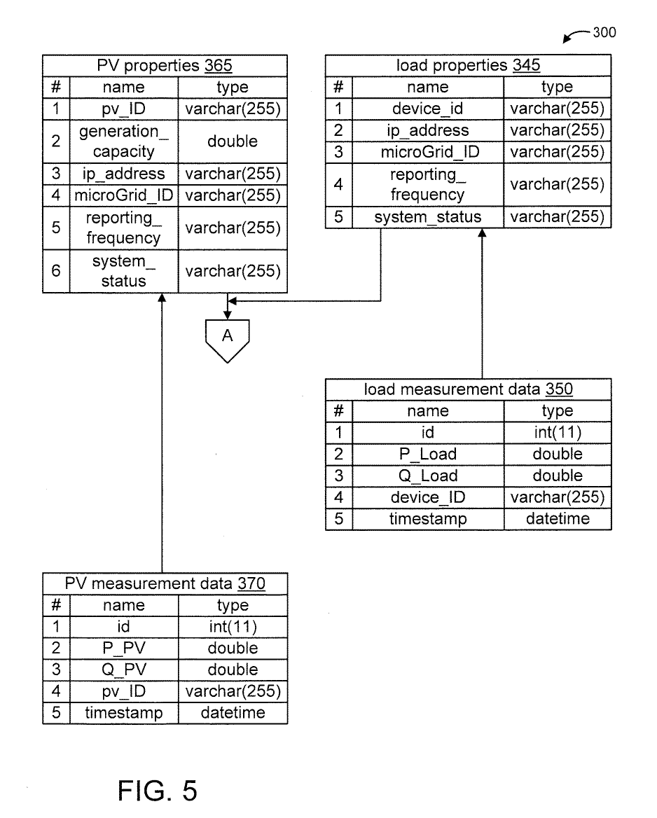

FIGS. 3-5 show exemplary database information 300 relating to the EMS Operational Platform 210 of FIG. 2.

The database information 300 includes micro grid properties 305, a load forecast result 310, a PV forecast result 315, diesel generator properties 320, diesel measurement data 325, ESS optimization information 330, ESS properties 335, ESS measurement data 340, load properties 345, load measurement data 350, micro grid measurement data 355, resilience controller properties 360, PV properties 365, and PV measurement data 370.

The micro grid properties 305 include a # field, a name field, and a type field for the following: microGridID; areaID; createdTime; grid_tied_mode; and operationStartTime.

The load forecast result 310 includes a # field, a name field, and a type field for the following: id; duration; microGrid_ID; timestamp; and value_kW.

The PV forecast result 315 includes a # field, a name field, and a type field for the following: id; duration; microGrid_ID; timestamp; and value_kW.

The diesel generator properties 320 includes a # field, a name field, and a type field for the following: diesel_device_ID; generator capacity; ip_address; microGrid_ID; reporting_frequency; and system_status.

The diesel measurement data 325 includes a # field, a name field, and a type field for the following: diesel_device_ID; generator capacity; ip_address; microGrid_ID; reporting_frequency; and system_status.

The ESS optimization information 330 includes a # field, a name field, and a type field for the following: id, ESS_ID; battery_original_life expectancy; flag; max_daily_degradation; microGrid_ID; modified_battery_profile; modified_daily_degradation; original_battery_profile; original_daily_degradation; rc_ID; and timestamp.

The ESS properties 335 includes a # field, a name field, and a type field for the following: ESS_ID; capacity; cell_capacity; cell_voltage; expected life; ip_address; max_SoC; max_power; microGrid_ID; min_SoC; peak_shaving_limit; ratedAh; reported_frequency; system_status; and voltage.

The ESS measurement data 340 includes a # field, a name field, and a type field for the following: id; P_ESS; Q_ESS; SOC; device_ID; and timestamp.

The load properties 345 include a # field, a name field, and a type field for the following: device_ID; ip_address; microGrid_ID; reporting_frequency; and system_status.

The load measurement data 350 includes a # field, a name field, and a type field for the following: id; P_Load; Q_Load; device_ID; and timestamp.

The micro grid measurement data 355 includes a # field, a name field, and a type field for the following: id; frequency; microGridID; mode; timestamp; and voltage.

The resilience controller properties 360 include a # field, a name field, and a type field for the following: resilience_controller_ID; csv_check_sec; http_server_port; ip_address; microgrid_ID; mode; reporting_frequency; system_status; and ui_port.

The PV properties 365 include a # field, a name field, and a type field for the following: pv_ID; generation_capacity; ip_address; microgrid_ID; reporting_frequency; and system_status.

The PV measurement data 370 includes a # field, a name field, and a type field for the following: id; P_PV; Q_PV; pv_ID; and timestamp.

Regarding the database information 300, the EMS Database 214 and EMS Operational Platform 210 need to be initiated. At first, the micro grids 220 are not registered. Once the micro grids 220 are configured in the EMS Database 214, the dynamic operation engine 211 tries to manage and optimize the micro grids 220 to which commands that control the grids are sent.

There are two ways to register and add micro grid configuration information in the EMS Database 214, namely: (1) Input by Operator: An EMS operator manually add the information of a micro grid to be added to the platform using User Interface provided by EMS Platform; and (2) Automatic Configuration by Micro Grid: When a micro grid is initiated, it automatically sends the info of its configuration to EMS Operational Platform, and then the platform registers it EMS Database.

An operator or a micro grid agent is responsible for configuring the micro grid devices such as batteries, loads, PVs, diesels. This realizes dynamic enhancement of the micro grids 220 (e.g., by adding more micro grids or energy devices).

FIGS. 6-7 show a method 600 performed by the dynamic operation engine 211 of FIG. 2, in accordance with an embodiment of the present invention.

At step 605, start the server of the EMS Operational Platform 210.

At step 610, establish a connection with the EMS database 214.

At step 615, register properties of the EMS Operational Platform 210 in the EMS database 214. The properties can include, but are not limited to, ID, IP address, port, system status, etc.

At step 620, initiate the dynamic operation engine 211 and set the running flag to true.

At step 625, determine whether the dynamic operation engine 211 is running. If so, then proceed to step 630. Otherwise, proceed to step 635.

At step 630, check the EMS database 214 to obtain the list of micro grid information.

At step 635, stop the dynamic operation engine 211.

At step 640, determine whether the micro grid is registered. If so, then proceed to step 645. Otherwise, proceed to step 675.

At step 645, for each micro grid, check its network connection, system status, and operational mode.

At step 650, determine, whether the micro grid is connected to the network. If so, then proceed to step 655. Otherwise, proceed to step 625.

At step 655, determine whether system status is active. If so, then proceed to step 660. Otherwise, proceed to step 675.

At step 660, determine whether the operational mode is an interactive mode. If so, then proceed to step 665. Otherwise, proceed to step 675.

At step 665, create operational and/or optimization commands for the micro grid and send the commands to its agents.

At step 670, determine if the command was processed successfully. If so, then proceed to step 675. Otherwise, the method is terminated.

At step 675, change the system status of the micro grid from “ACTIVE” to “FAILED”.

A further description will now be given regarding the micro grid diagnostic engine 212 of FIG. 2, in accordance with an embodiment of the present invention.

To that end, a procedure will be described regarding the autonomous failure or outlier detection mechanism so that each micro grid processes diagnostic polling messages sent from EMS Operational Platform 210 to see whether they are properly working or not. After a micro grid agent initiates the failure detection module, it updates the system status of itself and its devices in the EMS Database 214 so that the EMS Operational Platform 210 can start backup systems to recover the failure. There are two types of failure: communications failure; and application failure. In particular, applications failure can be detected by analyzing the content of response message of diagnostic polling such as the response code of HTTP message.

This is the autonomous mechanism to extract the system condition of the micro grids 220 and update the configuration information of the micro grids 220 in the EMS database 214 as well as state information of the micro grids 220. The EMS Operational Platform 210 then handles the results by diagnostic polling to the micro grids 220.

FIG. 8-9 show a method 800 performed by the micro grid diagnostic engine 212 of FIG. 2, in accordance with an embodiment of the present invention.

At step 805, initiate the micro grid diagnostic engine 212 and set the running flag to true.

At step 810, determine whether the micro grid diagnostic engine is running. If so, then proceed to step 815. Otherwise, proceed to step 865.

At step 815, for each micro grid, analyze the measurement data to extract outliers. System diagnostic process includes analyzing frequency, voltage, charging rate of batteries, grid power, and so forth.

At step 820, update the EMS database 214 to change the status of the micro grid and/or its energy systems (e.g., PVs, diesels, ESS) to FAILED mode or ACTIVE mode.

At step 825, for each micro grid, send a diagnostic polling message.

At step 830, determine whether a response message has been received. If so, then proceed to step 835. Otherwise, proceed to step 860.

At step 835, update the EMS database 214 to set the network connection status of the micro grid to CONNECTED.

At step 840, check the response content such as the HTTP response code.

At step 845, determine whether the response content indicates a system or application error. If so, then proceed to step 850. Otherwise, proceed to step 855.

At step 850, analyze the response content and update the EMS database 214 to change the status of the micro grid and/or its energy systems (e.g., PVs, diesels, ESS) to FAILED mode or ACTIVE mode.

At step 855, update the EMS database 214 to set the micro grid status to ACTIVE mode.

At step 860, update the EMS database 214 to set the network connection status of the micro grid to NOT CONNECTED.

At step 865, stop the micro grid diagnostic engine 212.

A further description will now be given regarding the system recovery engine 213 of FIG. 2, in accordance with an embodiment of the present invention.

Once the diagnostic engine to detect the outlier condition is initiated, the EMS Operational Platform 210 initiates a system recovery module using a back-up device or application.

In order to make the system recovery engine 213 function, we define the following two types of state information: (1) Failed: A micro grid is being failed by an unexpected incident/outlier; and (2) Updated: A micro grid is being updated by a system operator or engineer.

After checking that the backup system is appropriately configured and connected to the network, it starts the recovery process in both the EMS Operational Platform 210 and the back-up device.

After initiating all the modules described above, we can add and operate micro grid(s). The configuration information and its system status are all synchronized with the EMS database 214 accessed by EMS Operational Platform 210 so that once the information of micro grids or their devices is registered during the system initialization, the EMS Operational Platform 210 can detect the change of those modules in the EMS database 214 and conduct appropriate procedure to manage and optimize the micro grids 220.

FIGS. 10-11 show a method 1000 performed by the system recovery engine 213 of FIG. 2, in accordance with an embodiment of the present invention.

At step 1005, initiate the system recovery engine 213 and set the running flag to true.

At step 1010, determine whether the system recovery engine 213 is running. If so, then proceed to step 1015. Otherwise, proceed to step 1070.

At step 1015, for all registered micro grids, check the system status.

At step 1020, for all registered micro grids, determine whether the system status is FAILED. If so, then proceed to step 1025. Otherwise, proceed to step 1060.

At step 1025, for a failed micro grid, look up information of its backup device or application.

At step 1030, determine if the back device is application is registered. If so, then proceed to step 1035. Otherwise, proceed to step 1010.

At step 1035, for the registered backup device of the failed micro grid, check its network connection and system condition.

At step 1040, determine whether the registered backup device or application is connected to the network. If so, then proceed to step 1045. Otherwise, proceed to step 1010.

At step 1045, determine whether the backup system status is active. If so, then proceed to step 1050. Otherwise, proceed to step 1010.

At step 1050, construct commands for the micro grid devices (e.g., PVs, diesels, batteries, etc.) based on the duplicate application in the EMS Operational Platform 210.

At step 1055, send the commands to the backup device (the backup device will transfer the commands to the micro grid devices).

At step 1060, determine whether the system status is updated. If so, then proceed to step 1065. Otherwise, proceed to step 1010.

At step 1065, send an update micro grid command to change the state information of the micro grid and switch to a recovery application.

At step 1070, stop the system recovery engine 213.

A further description will now be given regarding various aspects of the present invention.

The dynamic configuration mechanism of the present invention focuses on how to set up, enhance, update, and recover micro grids and their energy devices in the EMS Operational Platform (such as a facilitator platform) so that it will not affect any other running systems and devices. In particular, the synchronization mechanism using the central EMS database 214 by dynamic operation engine 211, the micro grid diagnostic engine 212, and the system recovery engine 213 as well as micro grid-side configuration and operation agents is novel since the system state (e.g., running, not-running, failed) in the EMS database 214 can always be updated by diagnostic and recovery engines precisely in an orderly fashion and utilized by the dynamic operation engine in the platform.

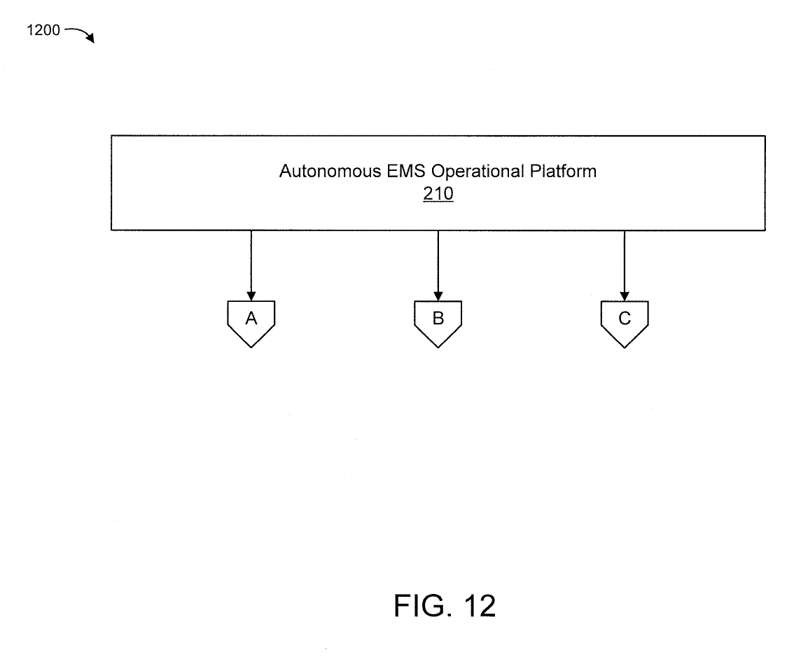

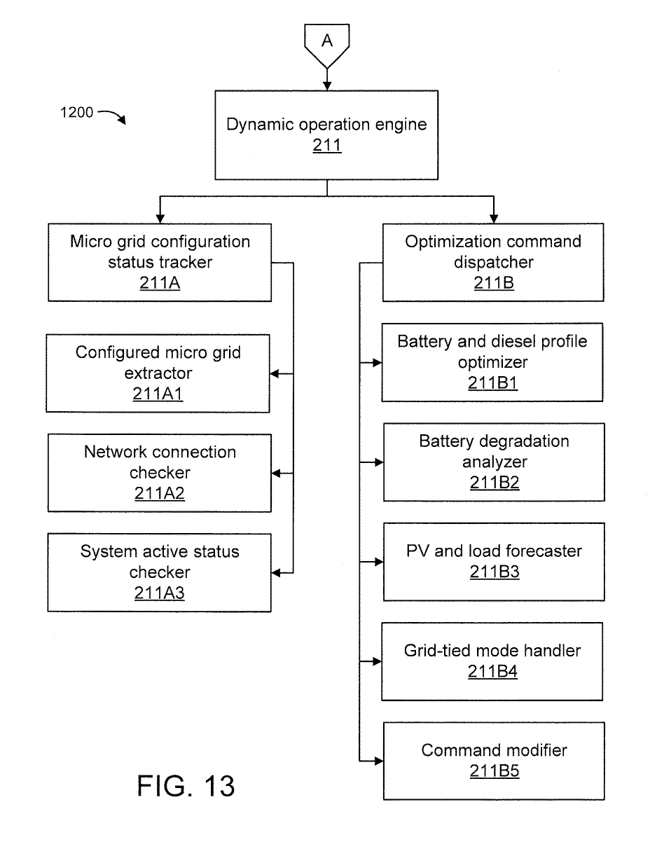

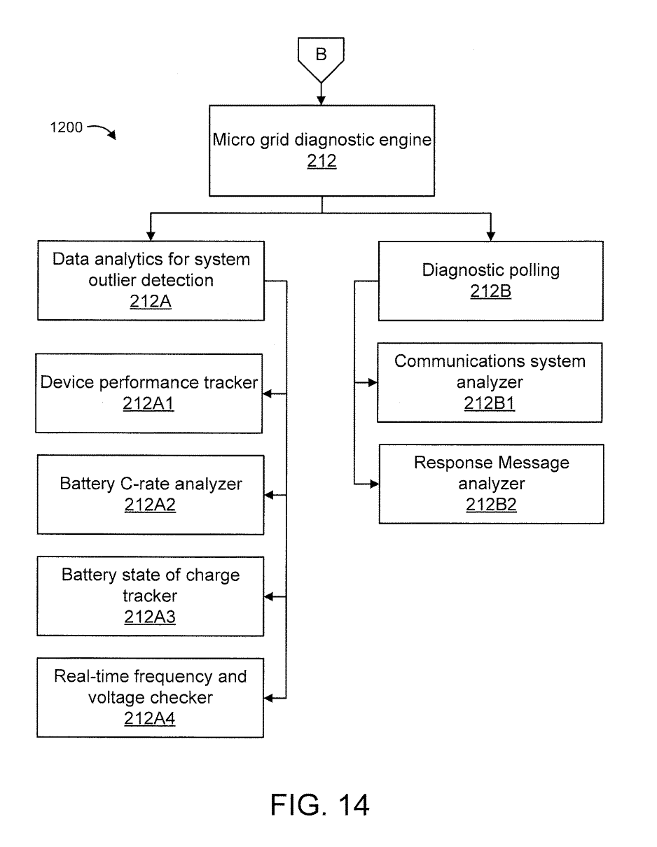

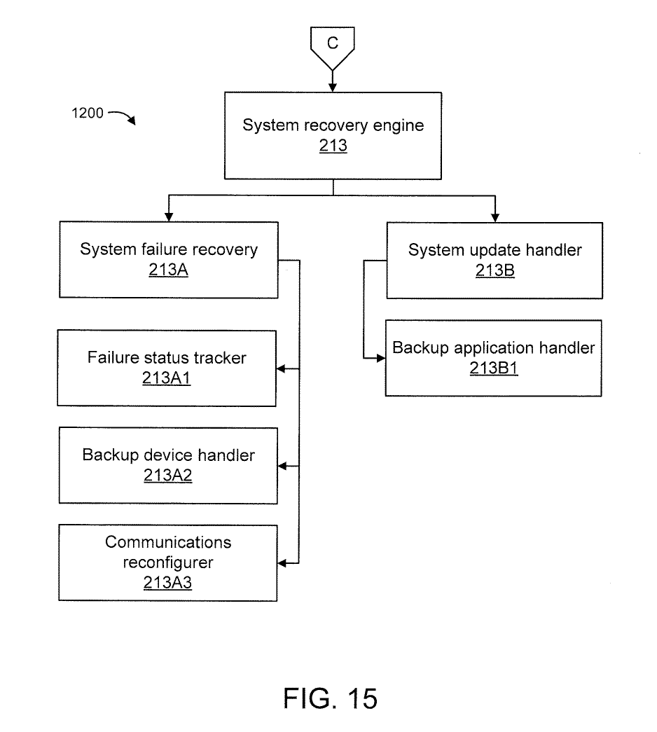

FIGS. 12-15 show another layout of an autonomous EMS Operational Platform architecture 1200, in accordance with an embodiment of the present invention.

The architecture 1200 includes an autonomous EMS Operational Platform 210 (for managing, updating, scaling up, and recovering micro grids). The EMS Operational Platform 210 includes a dynamic operation engine 211, a micro grid diagnostic engine 212, and a system recovery engine 213.

The dynamic operation engine 211 includes a micro grid configuration status tracker 211A and an optimized command dispatcher 211B.

The micro grid configuration status tracker 211A includes a configured micro grid extractor 211A1, a network connection checker 211A2, and a system active status checker 211A3.

The optimized command dispatcher 211B includes a battery and diesel profile optimizer 211B 1, a battery degradation analyzer 211B2, a PV and load forecaster 211B3, a grid-tied mode handler 2111B4, and a command modifier 211B5.

The micro grid diagnostic engine 212 includes data analytics for system outlier detection 212A and a diagnostic polling element (hereinafter interchangeably “diagnostics polling” in short) 212B.

The data analytics for system outlier detection 212A includes a device performance tracker 212A1, a battery Charging-rate (C-rate) analyzer 212A2, a battery state of charge tracker 212A3, and a real-time frequency and voltage checker 212A4.

The diagnostic polling 212B includes a communications status analyzer 212B1 and a response message analyzer 212B2.

The system recovery engine 213 includes a system failure recovery portion (hereinafter interchangeably “system failure recovery” in short) 213A and a system update handler 213B.

The system failure recovery portion 213A includes a failure status tracker 213A 1, a backup device handler 213A2, and a communications reconfigurer 213A3.

The system update handler 213B includes a backup application handler 213B1.

The dynamic operation engine 211 constantly keeps track of the configuration status of the micro grids 220 and checks whether any micro grid is added or removed from the EMS Database 214. It also keep track of the communications and system status of micro grids 220 and use the updated status information in dispatching operational or optimization commands to the micro grids 220. The combination of the following two key elements is necessary to realize dynamic operation that reflects the system condition of micro grids and devices.

The micro grid configuration status tracker 211A includes 3 key functions (211A1-211A3). The unique features of this element include constantly keeping track of the configuration information and state of a micro grid and its devices that have been uploaded by local controller and agents to the EMS Database 214 so that the results of the extracted data are utilized in the following dispatcher of optimization commands.

The optimization command dispatcher 211B includes elements 211B1-211B5. The battery and diesel profile optimizer 211B1 constructs a charging and discharging schedule to balance and optimize the micro grid. When dispatching and constructing the optimized commands to control batteries or diesels, the dynamic operation engine 211 checks their system status and reflects the status on constructing those commands.

The battery degradation analyzer 211B2 calculates the expected life of battery based on its usage such as charging rate. The result is integrated into the commands dispatched to micro grids to save the cost caused from degradation of a battery.

The PV and load forecaster 211B3 forecasts the future generation of PV(s) and the future consumption of load(s) within a micro grid, which is used in optimizing the charging and discharging control of a battery.

The grid-tied mode handler 211B4 optimizes the power coming from the utility electrical grid so that the supplies and loads are always balanced. The grid-tied mode handler 211B4 checks the grid-tied mode of a micro grid which is recorded in the EMS database 214.

One new mechanism, on top of the optimizers, analyzers, and forecaster above, is the command modifier 211B5 constantly reflecting the extracted results of the dynamic configuration and system status on the optimization results calculated in the other elements. For example, if the configuration tracker 211A founds out that a battery has failed, the optimization commands are modified to make up for the failure by cancelling the commands or adding commands to control other devices.

The micro grid diagnostic engine 212 includes a novel autonomous mechanism that essentially includes two ways of detecting failures and/or outliers in micro grids which are data analytics for system outlier detection 212A and diagnostic polling 212B. A micro grid agent is able to report measurement data from its energy systems periodically and store the data in the EMS database 214. From the data stored in the EMS database 214, the micro grid diagnostic engine 212 can detect any gap between operational commands and actual system behavior. By analyzing the gap of behaviors, the micro grid diagnostic engine 212 updates the system status of the micro grid and/or its devices so that operators or any other recovery modules can keep track of the outliers. In addition, the diagnostic polling 212B is the proactive way of detecting machine failure or outliers where the mechanism can employ typical communications analyzing methods and predefined message analyzer that specify the type of failure happening in a micro grid or its devices.

The data analytics for system outlier detection 212A primarily detects the outlier condition in micro grids by analyzing measurement data uploaded by agents of micro grids.

Regarding the device performance tracker 212A1, the EMS Database 214 has performance data reported by micro grid agents using an interval period. The EMS Operational Platform 210 has the history of optimization and operation commands sent to micro grids. Therefore, by constantly comparing the values in commands and the reported measurement data, it can capture any outlier that is happening in the micro grid. The EMS Operational Platform 210 could automatically change the system condition based on the outlier analysis and/or an operator can manually change the system status based on visualized data shown on a user interface such as Web Graphical User Interface (GUI).

The battery C-Rate analyzer 212A2 considers that C-Rate (Charging Rate) is strongly related to battery degradation especially when discharging power from a battery. The statistical analysis of C-rate is essential to keep the life of battery longer. If the value of C-rate is always large, then EMS Operational Platform 210 needs to modify the optimization commands not to overtask a battery.

The battery state of charge tracker 212A3 considers that the State of Charge (SoC) should be constantly captured by both the EMS Operational Platform 210 and an operator in order to see if it is effectively used or there is not unexpected leaking happening during micro grid operations. Any suspicious battery behavior should be automatically reported or detected by the operator.

Regarding the real-time frequency and voltage checker 212A4, if the frequency is not stable, then that indicates that the supplies and demands are not balanced. In that case, the system should immediately change the system state of the micro grid from “ACTIVE” to “FAILED” so that further analysis or recovery maintenance could be conducted.

The diagnostic polling element 212B includes the communications states analyzer 212B1 and the response message analyzer 212B2. Both of the analytical methods are based on the failure detection proposed in the area of network communications and distributed systems (e.g., with the analytical schemes being classified into specific categories defined by the components of the EMS for response message analysis. Therefore, the micro grid agent needs to have the function that can distinguish the types of device failures such as batteries and PVs to be able to report the system condition of them. The format should be predefined between the EMS Operational Platform 210 and micro grids 220 so that the EMS Operational Platform 210 can precisely capture the system states with the response messages from micro grids 220. After the detection of failure, the diagnostic polling element 212B updates the system status in the EMS database 214 and the status information is synchronized and utilized by the other engines in the EMS Operational Platform 210.

The failure detection mechanisms can also be distributed in the agents between the micro grids 220 on the basis of the neighboring structure of the micro grids 220. Extracting the topology among micro grids and creating a virtual topology over the grid is considered as an overlay network of micro grids. By integrating the concept of creating an overlay on top of micro grids, the EMS Operational Platform 210 can assign the adjacent topology of each micro grid so that with the local state information of adjacent micro grids, each agent can communicate with them to capture any failure happening among/in the micro grids 220.

The system recovery engine 213 is synchronized with the other engines that reflect the updated configuration or system state of the micro grid and devices. Use of the EMS Database 214 to synchronize the system status practically enables autonomous recovery of the micro grids 220. The system recovery engine 213 realizes automatic failure recovery and updating systems based on the back-up communications gateway devices and applications. Mechanisms to switch from main applications to back-up applications are key contributions to restoring systems without any interruptions, which leads to stable and resilient management and operation in the micro grids 220.

Regarding the system failure recovery portion 213A, a key idea when realizing the effective recovery is to apply the synchronization of system status using the central EMS database 214 that constantly captures micro grid dynamic operation status when recovering systems.

On the basis of the outlier analysis and polling results to micro grid(s) whose system status is constantly updated in the EMS database 214, the EMS Operational Platform 210 could quickly detect any failure by a real-time system condition tracking mechanism referred to herein as the failure status tracker 213A1.

The backup device handler 213A2 in the EMS Operational Platform 210 that uses back-up devices to restore from failures in the domain of micro grid failure recovery management. As the dynamic operation engine 211 captures the system properties specific to micro grid devices, the back-up application deployed in the EMS operational platform 210 covers the failure of the micro grid(s) 220 based on the measurement data stored in the EMS database 214, it is possible to minimize the risk of blackouts within the failed micro grid.

In addition, the system recovery engine 213 has the communications reconfigurer 213A3 to automatically change the gateway to which the optimization and operational commands are sent. This requires the reconfiguration of the HTTP server and client information including IP Address, Server Port, and so forth. Once all the communications information is reset up, the engine starts to communicate with back up device to send optimized commands that handle the balancing of supplies and loads.

The system update handler 213B updates the micro grid or its systems without hurting (detrimentally affecting) the current operations. A key concept of the backup application handler 213B1 is to copy the application used in the micro grid agent/controller and run it while updating the main application. If the micro grid system status is “Updated”, the EMS Operational Platform 210 is switching the application to use the duplicate copy in the micro grid including changing the communications port, frequency, and/or intervals. This is an essential function to conduct while the updated application turns out to be error-free and ready for use in real operations.

Key features are listed regarding elements 212A and 212B where the synchronization of thread computing by the dynamic operation engine 211, the micro grid diagnostic engine 212, and the system recovery engine 213 benefit over the operations for energy management systems when monitoring, enhancing, updating, and recovering the micro grid systems. Those features are dynamic, conducted in parallel, and synchronization elements in the EMS Operational Platform 210 described with respect to the device performance tracker 212A 1 will handle unexpected issues during daily operations. Those features could be combined with the commissioning operation while collecting measurement data to enhance the optimization and/or data analytics modules for more resilient, reliable, and effective control of micro grids.

A description will now be given of various significant features that solve some of the problems described herein.

(1) Thread computing for synchronizing configuration and system status: This is the key point for the diagnostic functions in order to update all the configuration and system operational status, which are all used in planning, scheduling, and dispatching optimization commands. By constantly looking into the EMS database 214 to grasp the change in each component's configuration or system status, the EMS Operational Platform 210 can quickly detect the updated state and goes to appropriate step to modify the system or the commands to be executed by devices. In addition, the EMS database 214 is designed to capture all the configuration and system status in a real-time manner so that EMS Operational Platform 210 can quickly refer to the EMS database 214 and let operators know the updated information or data analytics results at any time.
(2) Combination of autonomous outlier detection, system recovery mechanism, and dynamic operation based on the updated system status practically enables consistent operation, optimization, and restoration, all of which are critical to the management of the EMS and beneficial when scaling up an EMS having many micro grids installed. The cost of constantly monitoring the system status can be cut because of the autonomous nature of the failure restoration mechanisms described herein.

A description will now be given regarding any specific competitive/commercial values provided by the present invention.

By dynamically configuring and operating the energy management components such as micro grids and those devices, the EMS Operational Platform in accordance with the present invention can setup and enhance the EMS without interrupting the current operations, which leads to cutting the cost of stopping the systems and waiting until the systems are reconfigured or recovered.

The EMS database keeps track of all the systems configuration information, system conditions, and diagnostic results. This makes the operation of multiple micro girds less complicated and easier rather than just having state information in each micro grid that can be exchanged by messaging. Dynamic mechanism of switching the modules to use leads to resilient management of energy management systems as it will not affect any other running systems and enables us to operate the grids in sustainable manner.

Also, the EMS Operational Platform in accordance with the present invention provides dynamic procedures that are synchronized with micro grid controllers to enable operators of the grids to easily monitor the system configuration status and unexpected behaviors. In addition, based on the autonomous recovery mechanisms, operators do not have to constantly check the system status so that the labor cost could be reduced.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for managing a plurality of micro grids in an energy system, the method comprising:
collecting and maintaining, in a central database, configuration information and state information for the plurality of micro grids, by a processor-based dynamic operation engine;
identifying failures in any of the plurality of micro grids and generating updated configuration information and updated state information relating to the failures, based on data analytics and diagnostic polling applied to the configuration information and the state information, by a processor-based micro grid diagnostic engine; and
autonomously recovering from the failures in any of the plurality of microgrids using one or more backup devices determined based on the updated configuration information and the updated state information, by a processor-based system recovery engine operatively coupled to the processor-based dynamic operation engine and to the processor-based micro grid diagnostic engine.

2. The computer-implemented method of claim 1, wherein said identifying step identifies the failures based on differences between operational commands for the energy system and actual system behavior of the energy system, as determined from the configuration information and the state information.

3. The computer-implemented method of claim 1, wherein said autonomously recovering step selectively recovers from the failures in any of the plurality of microgrids using backup items selected from the group consisting of the one or more backup devices and one or more backup applications.

4. The computer-implemented method of claim 1, wherein the failures include impending failures determined from an application of the data analytics and the diagnostic polling to the configuration information and the state information.

5. The computer-implemented method of claim 4, further comprising preventing interruption of an operation of the energy system by the impending failures, by reconfiguring elements of the plurality of microgrids and using the backup devices.

6. The computer-implemented method of claim 1, further comprising deploying configuration agents among the plurality of micro grids to assist in an autonomous recovery from the failures in any of the plurality of microgrids using the one or more backup devices.

7. The computer-implemented method of claim 1, wherein a type of information, selected from the group consisting of the configuration information and the state information, is determined based on messages issued from elements of any of the plurality of micro grids.

8. The computer-implemented method of claim 7, wherein the messages include operational status data of the elements or command instructions for the elements.

9. The computer-implemented method of claim 8, wherein the elements are selected from the group consisting of photovoltaic devices, batteries, diesel generators, and loads.

10. The computer-implemented method of claim 1, further comprising optimizing an operation of the plurality of microgrids based on (i) the configuration information and the status information or (ii) the updated configuration information and the updated status information.

11. The computer-implemented method of claim 1, further comprising updating the central database responsive to (i) any of the plurality of micro grids being unregistered for use by the energy system and (ii) any additional micro grids being registered for use by the energy system.

12. The computer-implemented method of claim 1, wherein the state information for a given micro grid from among the plurality of micro grids applicably includes (i) a failed state indicative of an unexpected incident or outlier in the given micro grid and (ii) an updated state indicative of the given micro grid being currently updated.

13. The computer-implemented method of claim 1, wherein any of the plurality of micro grids are selectively in a grid-tied mode or a non-grid-tied mode with respect to being tied to a utility electrical grid, the applicable one of the modes being stored in the central database as a portion of the configuration information.

14. A computer-based energy management system for managing a plurality of micro grids in an energy system, the system comprising:
a processor-based dynamic operation engine for collecting and maintaining, in a central database, configuration information and state information for the plurality of micro grids;
a processor-based micro grid diagnostic engine for identifying failures in any of the plurality of micro grids and generating updated configuration information and updated state information relating to the failures, based on data analytics and diagnostic polling applied to the configuration information and the state information; and
a processor-based system recovery engine, operatively coupled to the processor-based dynamic operation engine and to the processor-based micro grid diagnostic engine, for autonomously recovering from the failures in any of the plurality of microgrids using one or more backup devices determined based on the updated configuration information and the updated state information.

15. The computer-based energy management system of claim 14, wherein said identifying step identifies the failures based on differences between operational commands for the energy system and actual system behavior of the energy system, as determined from the configuration information and the state information.

16. The computer-based energy management system of claim 14, wherein said autonomously recovering step selectively recovers from the failures in any of the plurality of microgrids using backup items selected from the group consisting of the one or more backup devices and one or more backup applications.

17. The computer-based energy management system of claim 14, wherein the failures include impending failures determined from an application of the data analytics and the diagnostic polling to the configuration information and the state information.

18. The computer-based energy management system of claim 17, further comprising preventing interruption of an operation of the energy system by the impending failures, by reconfiguring elements of the plurality of microgrids and using the backup devices.

19. The computer-based energy management system of claim 14, further comprising deploying configuration agents among the plurality of micro grids to assist in an autonomous recovery from the failures in any of the plurality of microgrids using the one or more backup devices.

20. The computer-based energy management system of claim 14, wherein the state information for a given micro grid from among the plurality of micro grids applicably includes (i) a failed state indicative of an unexpected incident or outlier in the given micro grid and (ii) an updated state indicative of the given micro grid being currently updated.
